(19) United States
(12) Patent Application Publication
(10) Pub. No.: US 2018/0071686 A1
(43) Pub. Date: Mar. 15, 2018

(54) SUBSEA WATER PROCESSING SYSTEM AND ASSOCIATED METHODS

(71) Applicant: General Electric Company, Schenectady, NY (US)

(72) Inventors: James Manio Silva, Clifton Park, NY (US); Hua Wang, Clifton Park, NY (US); Jose Luis Plasencia Cabanillas, Blommenholm (NO)

(21) Appl. No.: 15/265,528

(22) Filed: Sep. 14, 2016

(51) Int. Cl. B01D 61/20; C02F 1/44; C02F 1/467; C02F 1/469; B01D 63/10; B01D 71/42; B01D 61/42; B01D 61/14

(52) U.S. Cl. CPC B01D 61/20; C02F 1/444; C02F 1/467; C02F 1/4693; C02F 2103/10; B01D 71/42; B01D 61/422; B01D 61/142; B01D 63/10

(57) ABSTRACT

A subsea water processing system and associated methods are disclosed. The subsea water processing system includes a microfiltration unit, an ultrafiltration unit, and an electrochemical unit. The microfiltration unit includes an oil-tolerant microfiltration membrane and is configured to receive a stream of produced water and to produce a first treated stream of water. The ultrafiltration unit is fluidly connected downstream of the microfiltration unit, includes an oil-rejecting ultrafiltration membrane, and is configured to receive the first treated stream of water and to produce a second treated stream of water. The electrochemical unit is fluidly connected to at least one of the microfiltration unit or the ultrafiltration unit, and is configured to produce an acid and a base, and to deliver the acid, the base, or both the acid and the base to the at least one of the microfiltration unit or the ultrafiltration unit during a cleaning cycle.

### BACKGROUND

This disclosure generally relates to a subsea water processing system and associated methods of operating the system. In particular, this disclosure relates to a subsea water processing system for oil-water separation and methods of operating the system.

Petroleum reservoirs typically contain a mixture of water and hydrocarbon constituents (e.g., a mixture of water, oil and gas). To extract oil from the reservoir, various recovery mechanisms (e.g., primary, secondary or tertiary recovery processes) can be utilized. In a primary recovery process, oil constituents are displaced from a reservoir using the high natural pressure of the reservoir. For example, in an oil and gas well, petroleum can be recovered from the reservoir using the natural pressure of the reservoir itself. However, when the natural reservoir pressure declines, some enhanced recovery processes (e.g., an improved oil recovery process, IOR) may have to be used to extract more of the petroleum from the reservoir. For example, in a secondary process, a secondary stream of liquid or gas is injected into the reservoir to maintain a pre-determined reservoir pressure and drive the hydrocarbons to producing wells. One of the most commonly used secondary recovery processes is water flooding. In water flooding, water is injected, under pressure, into the reservoir to force, displace, or physically sweep the oil to adjacent production wells.

Subsea produced water treatment involves water separation and purification at seabed for re-injection (for IOR), injection into subsea disposal wells, or for environmentally safe discharge at the seabed. Besides minimization of the topside equipment footprint and protection of equipment from damage by weather, subsea produced water treatment for re-injection or discharge has many additional benefits. For example, a subsea produced water treatment system eliminates the need to store or transport huge volumes of water from subsea production sites to the tieback hosts. It also reduces the production system costs significantly. Further, it decreases the hydrostatic pressure on the subsea production flow lines to reduce back pressure on the subsea wellhead, which aids production. Equipment for subsea produced water treatment include, for example, oil/water separation systems, gas-liquid separation systems, suspended solids separators (de-sanders), and filtration systems. However, subsea water treatment faces many challenges, including difficulties in system mechanical design, electrification, control, inspection, fouling and scaling mitigation, maintenance and repair. Designs and operations that are typically used onshore and topsides in most cases cannot be directly used under subsea conditions. Today's conventional membrane systems and operational methods are designed for onshore and topsides applications. One major challenge in the operation of membrane filtration under subsea conditions is membrane fouling. Membrane fouling is indicated by the flux decline of a membrane system, which is caused by the accumulation of certain constituents (e.g. oil and solid particulates) on the surface of the membrane or in the membrane matrix.

Regular chemical cleaning of membrane modules, such as cleaning-in-place (CIP), is an integral part of membrane process operation. Regular membrane cleaning and removal of foulants extend membrane element life and overall system performance, and has a profound impact on the performance and economics of membrane processes. In membrane CIP, acidic and basic cleaning solutions are typically required to perform high pH and low pH cleaning. Chemical cleaning is also used in the prevention and remediation of scales. However, the conventional CIP systems and operation methods face many challenges in subsea applications. Therefore, a need exists for a subsea produced water treatment system having cleaning means suitable for cleaning filtration membranes, particularly at great water depths.

### BRIEF DESCRIPTION

In one aspect, a subsea water processing system is disclosed. The subsea water processing system includes a microfiltration unit, an ultrafiltration unit, and an electrochemical unit. The microfiltration unit includes an oil-tolerant microfiltration membrane. The microfiltration unit is configured to receive a stream of produced water and to produce a first treated stream of water. The stream of produced water includes at least some amount of oil constituents and suspended solids. The ultrafiltration unit is fluidly connected downstream of the microfiltration unit and includes an oil-rejecting ultrafiltration membrane. The ultrafiltration unit is configured to receive the first treated stream of water and to produce a second treated stream of water. The electrochemical unit is fluidly connected to at least one of the microfiltration unit or the ultrafiltration unit. The electrochemical unit is configured to produce an acid and a base, and further configured to deliver the acid, the base, or both the acid and the base to the at least one of the microfiltration unit or the ultrafiltration unit during a cleaning cycle.

In another aspect, a subsea water processing system is disclosed. The subsea water processing system includes a microfiltration unit, an ultrafiltration unit, and an electrochemical unit. The microfiltration unit includes an oil-tolerant microfiltration membrane. The microfiltration unit is configured to receive a stream of produced water that includes solid particulates having a mean particle size under 5 microns and oil constituents in a concentration ranging from about 25 to about 1000 parts per million. The microfiltration unit is further configured to produce a first treated stream of water from the stream of produced water during a filtration cycle. The first treated stream of water includes solid particulates having a mean particle size under 2 microns and oil constituents in a concentration that is at most 50% of the concentration of the oil constituents of the incoming produced water. The ultrafiltration unit includes an oil-rejecting ultrafiltration membrane. The ultrafiltration unit is configured to receive the first treated stream of water from the microfiltration unit and to produce a second treated stream of water during the filtration cycle. The second treated stream of water includes solid particulates having a mean particle size under 0.01 micron and oil constituents in a concentration of less than 20 parts per million. The electrochemical unit is configured to produce an acid and a base, and further configured to deliver the acid, the base, or both the acid and the base to the at least one of the microfiltration unit or the ultrafiltration unit during a cleaning cycle.

In yet another aspect, a method of processing produced water under subsea conditions using a subsea water processing system is disclosed. The subsea water processing system includes a microfiltration unit, an ultrafiltration unit and an electrochemical unit. The method includes the steps of filtering a stream of produced water using the microfiltration unit and the ultrafiltration unit to produce a stream of treated water during a filtration cycle, producing in situ acid and base in the electrochemical unit, and periodically washing at least one of the microfiltration unit or the ultrafiltration unit during an in situ cleaning cycle using at least one of the acid or the base produced by the electrochemical unit. The periodically washing step is performed to clean the at least one of the microfiltration unit or the ultrafiltration unit.

### BRIEF DESCRIPTION OF THE DRAWINGS

Various features, aspects, and advantages of the present invention will become better understood when the following detailed description is read with reference to the accompanying drawings in which like characters may represent like parts throughout the drawings. Unless otherwise indicated, the drawings provided herein are meant to illustrate key features of the disclosure. These key features are believed to be applicable in a wide variety of systems which comprises one or more embodiments of the invention. As such, the drawings are not meant to include all conventional features known by those of ordinary skill in the art to be required for practicing the invention.

FIG. 1 illustrates a schematic representation of subsea water processing system, according to some embodiments of the present disclosure.

FIG. 2 illustrates a schematic representation of subsea water processing system, according to some embodiments of the present disclosure.

FIG. 3 illustrates an example configuration of a subsea water processing system, according to some embodiments of the present disclosure.

FIG. 4 illustrates an example configuration of a subsea water processing system, according to some embodiments of the present disclosure.

FIG. 5 illustrates a bipolar electro dialysis (BPED) unit, according to some embodiments of the present disclosure.

FIG. 6 is a graphical illustration of rate of pH increase in the base stream and rate of pH decrease in the acid stream of a BPED stack when operated at room temperature, according to some embodiments of the present disclosure.

FIG. 7 is a graphical illustration of rate of pH increase in the base stream and rate of pH decrease in the acid stream of a BPED stack when operated at 4° C., according to some embodiments of the present disclosure.

### DETAILED DESCRIPTION

In the following specification and the claims, which follow, reference will be made to a number of terms, which shall be defined to have the following meanings.

The singular forms “a”, “an”, and “the” include plural referents unless the context clearly dictates otherwise. “Optional” or “optionally” means that the subsequently described event or circumstance may or may not occur, and that the description includes instances where the event occurs and instances where it does not. Approximating language, as used herein throughout the specification and claims, may be applied to modify any quantitative representation that could permissibly vary without resulting in a change in the basic function to which it is related. Accordingly, a value modified by a term or terms, such as “about” is not to be limited to the precise value specified. In at least some instances, the approximating language may correspond to the precision of an instrument for measuring the value.

To more clearly and concisely describe and point out the subject matter, the following definitions are provided for specific terms, which are used throughout the following description and the appended claims, unless specifically denoted otherwise with respect to particular embodiments.

As used herein, a membrane is referred as “oil-tolerant” if the performance of the membrane in an oil-containing feed is the same or within acceptable operable limits as the performance of the membrane in an oil-free feed stream. In other words, the performance of an oil-tolerant system does not change dramatically when oil is introduced into the system. For example, with an oil-tolerant membrane, flux of clean water or brine may not degrade rapidly when the feed contains oil.

As used herein, a membrane is referred as “oil-rejecting” if the suspended oil droplet content in the produced water from the membrane permeate is less than 100 ppm.

As used herein, the term “fluidly connected” refers to a physical connection that can be controlled to optionally establish a fluid transfer between the connected parts as and when required. For example, flow lines may be established for fluid transfer between the parts for physical connection and a valve may be placed between the physically connected parts, which upon opening can establish a fluid transfer.

As used herein “upstream” of a microfiltration unit refers to a side of the microfiltration unit that receives a stream of produced water for filtration, and “downstream” of the microfiltration unit refers to a side of the microfiltration unit that delivers a first treated stream of water. The term “upstream” of an ultrafiltration unit refers to a side of the ultrafiltration unit that receives the first treated stream of water for filtration, and the term “downstream” of the ultrafiltration unit refers to a side of the ultrafiltration unit that delivers a second treated stream of water. The term “upstream” of an electrochemical unit refers to a side of the electrochemical unit that receives salt water for the production of acid and base, and the term “downstream” of the electrochemical unit refers to a side of the electrochemical unit that delivers the produced acid and base.

Different embodiments of this disclosure present a subsea water processing system. The subsea water processing system includes a microfiltration unit, an ultrafiltration unit and operates to filter an incoming produced water stream in a filtration cycle. The stream of produced water includes at least some amount of oil constituents and suspended solids. The microfiltration unit includes an oil-tolerant microfiltration membrane and is configured to receive a stream of produced water and to produce a first treated stream of water in the filtration cycle. The ultrafiltration unit is fluidly connected downstream of the microfiltration unit and includes an oil-rejecting ultrafiltration membrane. The ultrafiltration unit is configured to receive the first treated stream of water from the microfiltration unit and to produce a second treated stream of water in the filtration cycle. The subsea water processing system further includes an electrochemical unit, which is fluidly connected to at least one of the microfiltration unit or the ultrafiltration unit. The electrochemical unit is configured to produce an acid and a base. During a cleaning cycle of the subsea water processing system, the electrochemical unit is configured to deliver acid, base, or both acid and base to the at least one of the microfiltration unit or the ultrafiltration unit.

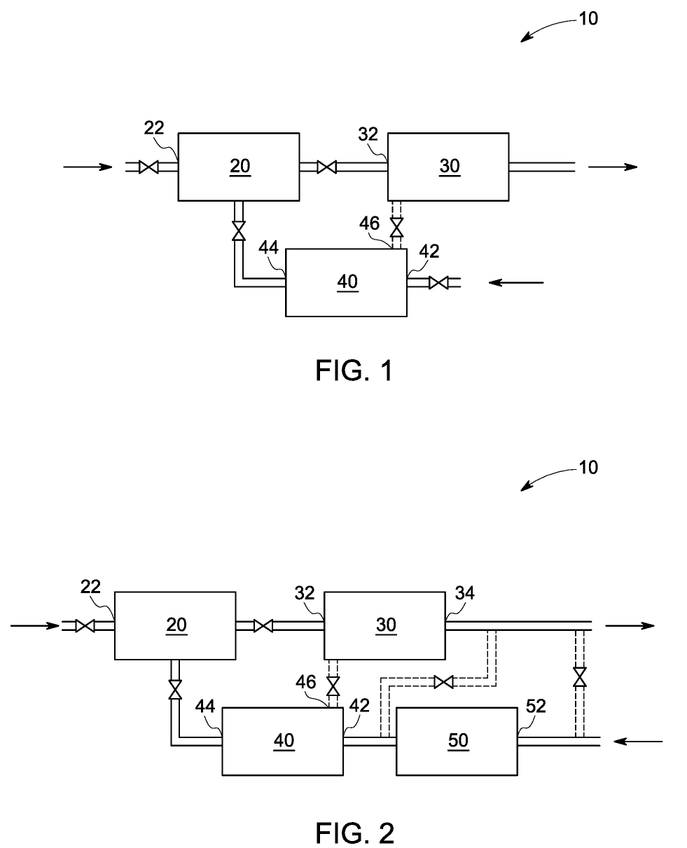

FIG. 1 illustrates a schematic diagram of a subsea water processing system 10 in accordance with some embodiments of the disclosure. The subsea water processing system 10 includes a microfiltration unit 20, an ultrafiltration unit 30, and an electrochemical unit 40. The microfiltration unit 20 is configured to receive a stream of produced water through an inlet 22 and to produce a first treated stream of water. The ultrafiltration unit 30 is fluidly connected downstream of the microfiltration unit 20. The ultrafiltration unit 30 is configured to receive the first treated stream of water from the microfiltration unit 20 through an inlet 32 and to produce a second treated stream of water. The electrochemical unit 40 is fluidly connected to at least one of the microfiltration unit 20 or the ultrafiltration unit 30. The electrochemical unit 40 is configured to produce an acid and a base. The electrochemical unit 40 includes an inlet 42 through which it receives salt water to produce the acid and the base. During the cleaning cycle, the electrochemical unit 40 is configured to deliver the acid or the base to the at least one of the microfiltration unit or the ultrafiltration unit through one of the outlets 44 or 46.

The stream of produced water subject to the filtration in the subsea water processing system 10 typically include at least some oil constituents and solid particulates. In some embodiments, the solid particulates are also contaminated with oil. In some embodiments, oil constituents of the stream of produced water includes free oil, suspended oil droplets (dispersed oil), emulsified oil, dissolved oil, and/or the oil contamination in the solid particulates. The solid particulates may be present in the produced water in the form of suspended solids. In some embodiments, the microfiltration unit 20 functions as a pre-filtration unit for the ultrafiltration unit. The microfiltration unit reduces the amount of oil constituents and number of solid particulates present in the stream of produced water to a particular level. The microfiltration unit reduces the number of solid particulates based on the pore size of the microfiltration membrane. The microfiltration unit further reduces the amount of oil constituents by filtering out oily particles. The ultrafiltration unit 30 further reduces the amount of the oil constituents and the solid particulates and generates a water stream that can be discharged safely or used for re-injection. In some embodiment, the ultrafiltration unit 30 reduces the number of solid particulates by virtue of its fine pore size and the amount of suspended oil droplets by virtue of its oil-rejecting properties. At least one of the acid or base produced by the electrochemical unit 40 is periodically used for cleaning the at least one of the microfiltration unit 20 or ultrafiltration unit 30. Periodic cleaning of the microfiltration and/or ultrafiltration unit ensures efficient operation (filtration of the produced water) of the subsea water processing system for longer periods. Washing of at least one of the microfiltration unit 20 or ultrafiltration unit 30 primarily includes washing the membranes of the microfiltration unit 20 and/or the ultrafiltration unit 30.

The stream of produced water may be optionally pre-treated in one or more of hydrocyclones, oil-water separators, desanders, or deoilers prior to the filtration in the microfiltration unit 20. Depending on the optional pre-treatment of the stream of produced water before filtration in the microfiltration unit 20, the size and/or volume percentages of the constituents of the stream of produced water entering the microfiltration unit may vary.

For example, the microfiltration unit may receive a stream of produced water having suspended oil droplet content of up to 1000 parts per million (ppm) in the absence or limited use of a bulk pre-treatment system. In contrast, in the bulk pre-treated stream of produced water, the concentration of suspended oil droplets may be under 100 ppm. The microfiltration unit 20 includes an oil-tolerant microfiltration membrane so that the filtration performance (e.g., membrane permeability) of the microfiltration membrane does not dramatically decrease while filtering the stream of produced water that contains suspended oil droplets. In some embodiments, the performance of the oil-tolerant microfiltration membrane may not decrease more than 10% when operated continuously without any cleaning process for more than a week. In some embodiments, the performance of the oil-tolerant microfiltration membrane may not decrease more than 10% when operated continuously without any cleaning process for up to a month. The oil-tolerance of the microfiltration membrane may be induced by increasing the membrane oleophobicity, for example, by applying an oleophobic coating to the membrane. The oleophobicity of the microfiltration membrane aids by repelling suspended oil droplets and oily particulates in produced waters that rapidly foul conventional membranes. Suspended oil droplets and oily particles that are smaller than the membrane mean pore size may pass through the membrane while being repelled by the oleophobic membrane, whereas particles and droplets that are larger than the membrane mean pore size may accumulate as part of a cake layer that can be washed off the membrane surface. For example, residue from the cake layer may be easily washed off using an acid or a base (after conventional backwashing), and the membrane itself may be cleaned by flowing an acid or base stream through the membrane. In some embodiments, the microfiltration unit 20 may have a plurality of oil-tolerant microfiltration membrane elements. In some embodiments, the oil-tolerant microfiltration membrane of the microfiltration unit 20 is also hydrophilic. Membrane hydrophilicity aids membrane performance by enabling streams such as oil-containing waste water to be readily filtered without requiring pre-wetting the membrane with organic solvents prior to water filtration. In some embodiments, the microfiltration unit includes one or more oil-tolerant microfiltration membrane elements that are both hydrophilic and oleophobic. Incorporation of both hydrophilicity and oleophobicity to a filtration membrane enables efficient filtration of produced water to remove suspended oily particles and suspended oil droplets. In absence of such coatings, oil constituents (e.g., as emulsified, dissolved, or free oil in produced water) rapidly foul a microfiltration membrane.

The pore sizes of the microfiltration membrane of the microfiltration unit 20 may vary in the subsea water processing system. In some embodiments, the average pore size of the microfiltration membrane is less than 5 microns. In certain embodiments, the average pore size of the microfiltration membrane is less than 2 microns. In some specific embodiments, the microfiltration unit has a microfiltration membrane having its average pore size less than 1 micron. In some embodiments, the pore size of the microfiltration membrane is equal to or greater than 0.1 microns.

In some embodiments, the microfiltration unit includes polymeric microfiltration membranes. In some embodiments, the microfiltration membrane includes a porous substrate and optionally a coating attached to the porous substrate. In some embodiments, at least one of the substrate or the coating includes polytetrafluoroethylene (PTFE) or expanded polytetrafluoroethylene (ePTFE). In some embodiments, the at least one of the substrate or the coating includes a copolymer having 1 to 50 mole % of a structural unit of formula I and 25 to 99 mole % of a structural unit of formula II. In some embodiments, the at least one of the substrate or the coating includes a copolymer having 1 to 10 mole % of a structural unit of formula I and 90 to 99 mole % of a structural unit of formula II.

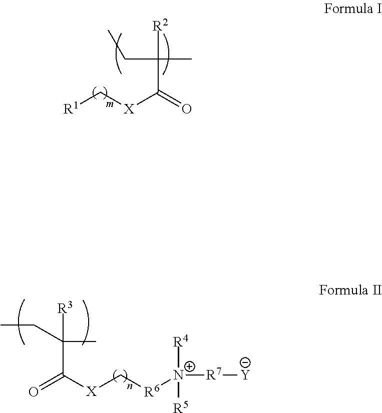

In some embodiments, a copolymer comprising structural units derived from a mixture of ethylenically unsaturated monomers comprising 1 to 50 mole % of fluoroalkyl monomer of formula III and 25 to 99 mole % of zwitterionic monomer of formula IV is provided. In some embodiments, the copolymer having structural units derived from a mixture of ethylenically unsaturated monomers comprising 1 to 10 mole % of fluoroalkyl monomer of formula III and 90 to 99 mole % of zwitterionic monomer of formula IV.

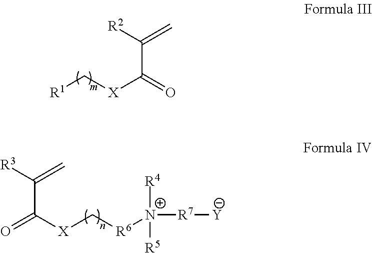

In formulas I II, III, and/or IV, R¹ is a linear or branched C₁-C₃₀ fluoroalkyl group; R² and R³ are independently at each occurrence a hydrogen, or a linear or branched C₁-C₄ alkyl group. In some embodiments, R⁴ and R⁵ are independently at each occurrence a linear or branched C₁-C₁₂ alkyl group, a C₅-C₁₂ carbocyclic group, or a C₅-C₁₂ heterocyclic group; and R⁶ and R⁷ are independently at each occurrence a linear or branched C₁-C₁₂ alkynylene group, a linear or branched C₂-C₁₂ alkenylene group, a linear or branched C₂-C₁₂ alkynlene group, a C₅-C₁₂ carbocyclic group, or a C₅-C₁₂ heterocyclic group. In some other embodiments, at least two of R⁴, R⁵, R⁶, or R⁷ together with the nitrogen atom to which they are attached may form a heterocyclic ring containing 5 to 7 atoms. X is independently at each occurrence either an oxygen atom (—O—) or an —NH— group; and Y is either a sulfite group or a carboxylate group. The values of m and n are independently at each occurrence an integer ranging from 1 to 5.

In some embodiments, the microfiltration membrane including a porous substrate and optionally a coating attached to the porous substrate is provided, wherein at least one of the porous substrate or the coating includes a polymeric composition containing a copolymer comprising 1 to 50 mole % of a structural unit of formula V, and 25 to 99 mole % of a structural unit of formula VI, wherein R¹ is a linear C₅-C₈ fluoroalkyl group. In some embodiments, at least one of the porous substrate or the coating includes a polymeric composition containing a copolymer comprising 1 to 10 mole % of a structural unit of formula V, and 90 to 99 mole % of a structural unit of formula VI.

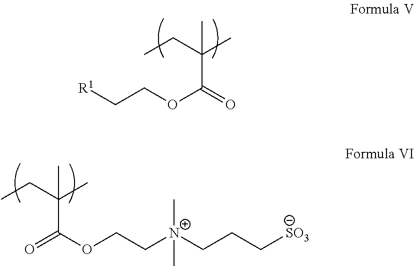

The microfiltration membrane of the microfiltration unit 20 may have a shape that is amenable for washing of the rejected oil constituents. In some embodiments, the microfiltration membrane has a shape of an array of candle filter elements mounted on a tube sheet. In some embodiments, the microfiltration membrane is a backpulse membrane amenable for washing in a backflushing mode.

The first treated stream of water produced by the microfiltration unit 20 in a filtration cycle has solid particulates having substantially reduced mean particle size and further has a substantial reduction in oil constituents content as compared to the stream of produced water received by the microfiltration unit 20. In some embodiments, the first treated water includes solid particulates that have mean particle size less than 2 microns. In some embodiments, the first treated water includes solid particulates that have mean particle size up to about 1.5 microns. In some embodiments, the first treated water includes solid particulates that have a mean particle size up to about 1 micron. In some embodiments, the first treated water includes solid particulates that have a mean particle size greater than 0.005 micron. In some embodiments, the first treated water includes solid particulates that have a mean particle size in the range from about 0.005 micron to about 1 micron. In some embodiments, the content of oil constituents in the first treated water may be reduced by at least 50% of the stream of produced water. In some embodiments, the first treated stream of water has a 75% reduction in oil constituent as compared with the stream of produced water.

The ultrafiltration unit 30 includes an oil-rejecting ultrafiltration membrane. In some embodiments, the oil-rejecting membrane of the ultrafiltration unit is such that the treated stream leaving the membrane (the permeate) contains less than 50 ppm of suspended oil droplets. In certain embodiments, the oil-rejecting membrane of the ultrafiltration unit is such that the permeate contains less than 20 ppm of suspended oil droplets. The oil-rejection capability of the ultrafiltration membrane is generally induced by the combination of the high hydrophilicity and fine pore sizes of the ultrafiltration membrane. Fine pore sizes of the ultrafiltration membrane provide a size barrier for both the oily particulates and the suspended oil droplets. In some embodiments, the pore sizes of the ultrafiltration membrane are less than 0.1 micron. In some embodiments, the pore sizes of the ultrafiltration membrane are greater than 0.005 micron. In some embodiments, the pore sizes of the ultrafiltration membrane are in the range from about 0.005 micron to about 0.1 micron. In certain embodiments, the mean pore size of the ultrafiltration membrane is about 0.01 micron. In some embodiments, the ultrafiltration unit 30 may have a plurality of oil-rejecting ultrafiltration membranes.

In some embodiments, the ultrafiltration unit includes polymeric ultrafiltration membranes. In some embodiments, the ultrafiltration unit comprises a polyacrylonitrile membrane. In some other embodiments, depending on the shape of the ultrafiltration membrane, the ultrafiltration membrane may be amenable to a forward wash, but may not be amenable to backwashing. In some embodiments, the ultrafiltration membrane is in a spiral wound form. In some specific embodiments, the ultrafiltration membrane is in a spiral wound form and includes polyacrylonitrile.

During the filtration cycle, the ultrafiltration unit 30 accepts the first treated stream of water from the microfiltration unit 20 and produces the second treated stream of water. In some embodiments, the second treated stream of water produced by the ultrafiltration unit 30 has solid particulates that have a mean particle size less than 0.01 micron. In some embodiment, the second treated stream of water produced by the ultrafiltration unit 30 is substantially free of suspended solids. There may be a substantial reduction in oil constituent content in the second treated stream of water as compared to the first treated stream of water received by the ultrafiltration unit 30. In some embodiments, the oil constituents content in the second treated stream of water is less than 20 parts per million (ppm).

Depending on the end use of the second treated stream of water, the system 10 may further have a nanofiltration unit and/or a reverse osmosis unit (not shown in figures) that receives the second treated stream of water from the ultrafiltration unit and further purifies it for re-injection. The subsea water processing systems including such additional purification units, along with the microfiltration unit 20, the ultrafiltration unit 30, and the electrochemical unit 40 disclosed herein, are considered to be a part of this disclosure.

The electrochemical unit 40 of the subsea water processing system is configured to produce acid and base from a salt water. When the electrochemical unit 40 is a bipolar electrodialysis unit, it uses a bipolar membrane to split water into protons (H⁺) and hydroxide (OH⁻) ions, generating acid and caustic streams. In some embodiments, the electrochemical unit 40 may have a cell and stack configuration. The cell and stack configuration may be of single compartment, 2-compartment, 3-compartment, or multi-compartment configuration. The electrochemical unit may have monopolar electrodes, bipolar electrodes, porous separators, cation-exchange membranes, anion-exchange membranes, or bipolar membranes.

In certain embodiments, a subsea water processing system 10 includes a microfiltration unit 20, an ultrafiltration unit 30, and an electrochemical unit 40. The microfiltration unit 20 includes an oil-tolerant microfiltration membrane and is configured to receive a stream of produced water that includes solid particulates having a mean particle size under 5 microns and oil constituents in a concentration ranging from about 25 to about 1000 parts per million. In some embodiments, the stream of produced water includes solid particulates having a mean particle size up to 5 microns. The microfiltration unit is further configured to produce a first treated stream of water from the stream of produced water during a filtration cycle. The first treated stream of water includes solid particulates having a mean particle size under 2 microns and oil constituents in a concentration that is at most 50% of the concentration of the hydrocarbons of the produced water. In some embodiments, the microfiltration unit 20 reduces the oil constituents from greater than 1000 ppm (in the stream of produced water) to less than 500 ppm (in the first treated stream of water). The ultrafiltration unit includes an oil-rejecting ultrafiltration membrane. The ultrafiltration unit is configured to receive the first treated stream of water from the microfiltration unit and to produce a second treated stream of water during the filtration cycle. The second treated stream of water includes solid particulates having a mean particle size under 0.01 micron and oil constituents in a concentration of less than 20 parts per million. The electrochemical unit is configured to produce an acid and a base, and is further configured to deliver the acid, the base, or both the acid and the base to the at least one of the microfiltration unit or the ultrafiltration unit during a cleaning cycle.

In some embodiments, the subsea water processing system 10 is a unitary system having the microfiltration unit 20, the ultrafiltration unit 30 and the electrochemical unit 40 as the constituents of the unitary system. This unitary system ensures an independent and uninterrupted long-term functioning of the subsea water processing system, without any external supply of chemicals for cleaning the filtration units. The functioning of this unitary system thereby further aids in reducing topsides space requirements for the water treatment. In some embodiments, the electrochemical unit 40 generates acid and base from sea water. However, often sea water fouls the membranes of the electrochemical unit 40. In some embodiments, the ultrafiltration unit 30 is further configured to deliver at least a portion of the second treated water to the electrochemical unit 40 through an ultrafiltration outlet 34, as shown in FIG. 2. In some embodiments, the subsea water processing system includes a nanofiltration unit 50 having an inlet 52 fluidly connected upstream of the electrochemical unit 40 to supply filtered water to the electrochemical unit 40. The nanofiltration unit 50 has one or more nanofiltration membrane modules. The nanofiltration units may be employed to remove sulfate ions and other divalent ions such as calcium and magnesium from the stream feeding the electrochemical unit 40. Suitable nanofiltration units include SWSR and the D-Series spiral wound nanofiltration membrane units (GE Power and Water) SR90 spiral wound nanofiltration membrane units (DOW), and NANO-SW-Series spiral wound nanofiltration membrane units (Hydranautics-Nitto). In some specific embodiments, the nanofiltration unit 50 may be configured to receive sea water and produce a third treated stream of water and deliver the same to the electrochemical unit 40 as shown in FIG. 2. In other embodiments, the nanofiltration unit 50 is configured to receive the second treated stream of water produced from the ultrafiltration unit 30 and produce therefrom the third treated stream of water. In some embodiments, the third treated stream of water may contain less than 100 parts per million sulfate species (e.g. CaSO₄). In some embodiments, the nanofiltration unit is configured to receive the second treated stream of water and produce therefrom a nanofiltrate containing less than 50 parts per million sulfate ions (SO₄²⁻). In some embodiments, the nanofiltrate contains less than 150 parts per million of combined calcium and magnesium ions. In other embodiments, the nanofiltrate contains less than 50 parts per million of combined calcium and magnesium ions. In one or more embodiments, the nanofiltrate contains less than 10 parts per million of combined calcium and magnesium ions.

In certain embodiments, the electrochemical unit 40 is a bipolar membrane electrodialysis (BPED) unit configured to produce hydrochloric acid and sodium hydroxide. In a BPED unit, water is split into hydroxide ions and protons by a disproportionation reaction at the surface boundaries between anionic and cationic layers. The produced hydroxide ion and proton are separated under electric field by migration across the respective membranes. This is distinct from water redox reaction at electrodes during electrolysis as there is no gas evolution such as hydrogen and oxygen gases as a side product at the surface of bipolar membranes units. The BPED unit in the current disclosure uses sea water, produced water, or a treated stream of water as input and produces aqueous hydrochloric acid as an acid output and aqueous sodium hydroxide as a base output.

In some embodiments, a method of processing produced water under subsea conditions by the operation of a subsea water processing system is disclosed. The subsea water processing system includes a microfiltration unit, an ultrafiltration unit and an electrochemical unit. The method includes the steps of filtering a stream of produced water using the microfiltration unit and the ultrafiltration unit to produce a stream of treated water during a filtration cycle, producing in situ an acid and a base in the electrochemical unit, and periodically washing at least one of the microfiltration unit or the ultrafiltration unit during an in situ cleaning cycle using at least one of the acid or the base produced by the electrochemical unit.

During the in situ cleaning cycle, the acid or base may be circulated to at least one of the microfiltration unit 20 or the ultrafiltration unit 30 via acid and base solution flow lines. Different valves may be used to control flow of acid and/or base during the cleaning cycle. In some embodiments, in situ cleaning cycle is performed in the same flow direction as the filtration cycle. One or more booster pumps may be connected to the electrochemical unit 40 for feeding the input water for the production of acid and base in the electrochemical unit and delivering the acid and/or base to the microfiltration unit 20 and/or the ultrafiltration unit 30.

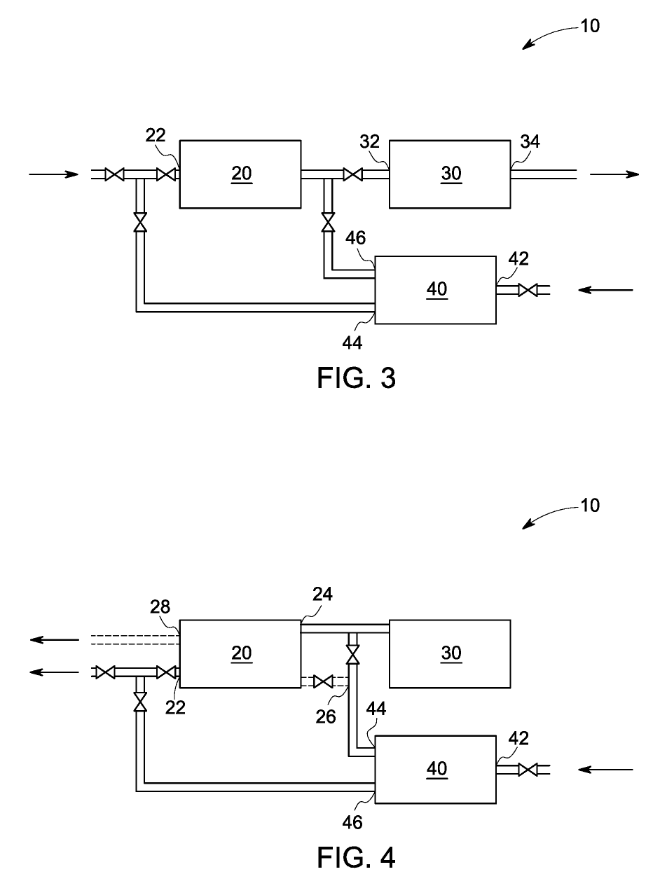

In the filtration cycle, during operation of the subsea water processing system 10, the microfiltration unit 20 filters the incoming stream of produced water and delivers a first treated stream of water. The ultrafiltration unit 30 further filters the first treated stream of water and delivers a second treated stream of water, which may be used for discharge or re-injection purposes. In the cleaning cycle, different configurations may be used for the cleaning of microfiltration membrane, ultrafiltration membrane, or both the microfiltration membrane and the ultrafiltration membrane, such as, for example, illustrated in FIGS. 3 and 4. In some embodiments, the at least one of the microfiltration unit 20 or the ultrafiltration unit 30 is further configured to receive acid or base from the electrochemical unit 40 during the cleaning cycle.

In one configuration, an in-line washing step in the cleaning cycle may be used for cleaning the microfiltration membrane and/or the ultrafiltration membrane. In some embodiments, the subsea water processing system 10 is configured to receive acid or base from the electrochemical unit 40 upstream of the at least one of the microfiltration unit or the ultrafiltration unit during a washing step of the cleaning cycle. In these embodiments, an outlet of the electrochemical unit 40 is fluidly connected to an inlet of the at least one of the microfiltration unit 20 or the ultrafiltration unit 30. FIG. 3 is an exemplary illustration of this configuration for cleaning of the microfiltration membrane. In this configuration, in some embodiments, the outlet 44 of the electrochemical unit 40 is fluidly connected upstream of the microfiltration unit 20. Another outlet 46 of the electrochemical unit 40 is fluidly connected downstream of the microfiltration unit 20, but upstream of the ultrafiltraion unit.

In some embodiments, a cleaning process in an in situ cleaning cycle is conducted by interrupting the filtration cycle of the system 10. The filtration cycle may be stopped and an acid or base may be disposed upstream of the microfiltration unit 20 to wash the microfiltration membrane. The acid or base may be disposed to the microfiltration unit through the existing inlet 22 or using a separate inlet to the microfiltration unit 20 (not shown in FIG. 3). In some embodiments, the outlet 44 of the electrochemical unit is fluidly connected to the inlet 22 of the microfiltration unit (e.g., FIG. 3). A wash stream delivered from the microfiltration unit 20 after cleaning the microfiltration membrane may still be acidic if an acid stream is used for washing. Similarly, a wash stream delivered from the microfiltration unit 20 after cleaning the microfiltration membrane may still be alkaline if a basic stream is used for washing. It is desirable to neutralize this stream before the stream is discharged from the subsea water processing system 10. A neutralization stream may be delivered from the electrochemical unit 40 through the outlet 46 to downstream of the microfiltration unit for neutralizing the wash stream (e.g., FIG. 3). A base may be delivered to neutralize an acidic wash stream and an acid may be delivered for neutralize a basic wash stream. In some embodiments, the wash stream after cleaning the microfiltration membrane of the microfiltration unit 20 is disposed through the outlet 24 and neutralized by the acid or base delivered through the outlet 46 of the electrochemical unit 40. In some other embodiments, the wash stream after cleaning the microfiltration membrane of the microfiltration unit 20 is disposed through a separate outlet (not shown in figures) other than outlet 24 and neutralized by the acid or base delivered through the outlet 46 of the electrochemical unit 40. The pH of the acid or the base used for washing and/or pH of the base or acid stream used for neutralizing may be adjusted for the intended application by controlling the acid and base production in the electrochemical unit. Different valves and pumps (not shown in figure) may be used for controlling the flow of acid and base from the electrochemical unit 40. In some of these embodiments, the filtration cycle and the in situ cleaning cycle are performed alternately to periodically wash the membranes of the microfiltration unit 20 and/or the ultrafiltration unit 30.

In one configuration, a back washing step in the cleaning cycle is used for cleaning the microfiltration membrane and/or the ultrafiltration membrane. In this configuration, the in-situ cleaning cycle is performed in a flow direction opposite to the filtration cycle. Typically, a treated water is used to back wash the membranes. In some embodiments of this disclosure, the subsea water processing system 10 is configured to receive the acid or the base from the electrochemical unit 40 downstream of the at least one of the microfiltration unit 20 or the ultrafiltration unit 30 during a back washing step of the cleaning cycle. FIG. 4 shows an exemplary embodiment for back washing, specifically illustrating a configuration for cleaning of the microfiltration membrane. In this configuration, in some embodiments, the outlet 44 of the electrochemical unit is fluidly connected downstream of the microfiltration unit 20. Another outlet 46 of the electrochemical unit 40 is connected upstream of the microfiltration unit 20. In this configuration, the cleaning process in the in situ cleaning cycle is conducted by interrupting the filtration cycle of the system 10. The filtration cycle may be stopped and an acid or base may be disposed downstream (with respect to the normal filtration flow) of the microfiltration unit 20 to wash the microfiltration membrane in a backflushing mode. The acid or the base may be fed to the microfiltration unit through the filtrate outlet 24 or using a separate inlet 26 to the microfiltration unit 20. A neutralization stream may be delivered from the electrochemical unit through the outlet 46 upstream of the microfiltration unit 20 for neutralizing the wash stream. The neutralization stream may be delivered to the produced water inlet 22 of the microfiltration unit, to a separate wash stream outlet 28, or to a reservoir (not shown in the figure) collecting the wash stream during the cleaning cycle. The pH of the acid or the base used for washing and/or pH of the base or acid used for neutralizing may be adjusted for the intended application by controlling the acid and base production in the electrochemical unit 40. Different valves and pumps (not shown in figure) may be used for controlling the flow of acid and base from the electrochemical unit 40.

In some specific embodiments, acid from the electrochemical unit is delivered upstream of the microfiltration unit through outlet 44 (as shown in FIG. 3) and diluted with incoming produced water stream to less than pH 4 for low pH cleaning of the microfiltration membrane. The residual acids in the microfiltration permeate is neutralized with the base from the electrochemical unit through outlet 46.

Stopping the filtration of water during cleaning cycle results in down-time for water re-injection. In some embodiments, additional parallel membrane units may be used to provide extra permeate while the cleaning cycle is in progress for the normally used membrane units. Sometimes additional tanks and pumps may be needed in these configurations.

### Examples

Proof-of-concept experiments have demonstrated the capability to produce acid and base from seawater on-site and on-demand Salts for making synthetic seawater for this experiment include KCl, MgCl₂, CaCl₂, NaCl, and NaHCO₃ (all from Sinopharm Chemical Reagent Co., Ltd). Acid and base solutions were prepared from concentrated hydrochloric acid solution and solid NaOH (Sinopharm Chemical Reagent Co., Ltd).

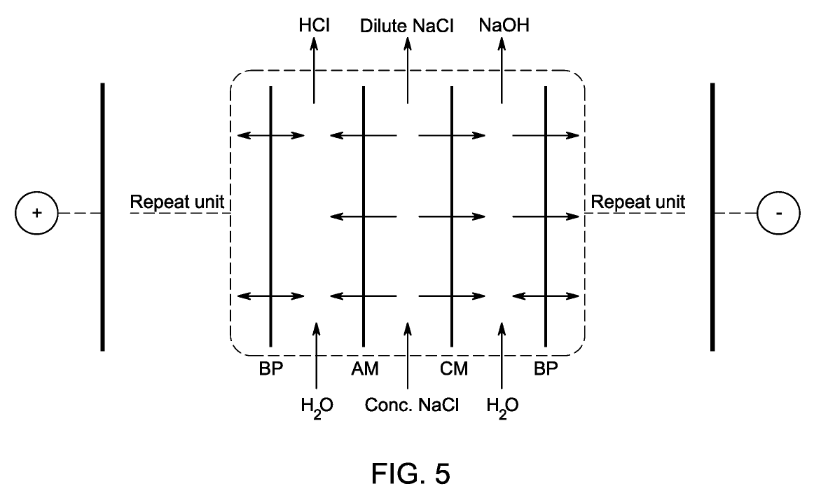

Experiments were conducted using a BPED stack (GE Power & Water). FIG. 5 shows a schematic representation of one membrane unit included in the BPED stack. The BPED stack included 6 such membrane units. The single BPED membrane unit consists of one anion exchange membrane (AM), one cation exchange membrane (CM) and a composite bipolar membrane (BP) made of a cation exchange membrane and an anion exchange membrane. During operation, charging of the stack induces a water splitting reaction at the surface of the bipolar membranes and protons and hydroxide ions are generated. In addition, a reduction reaction occurs at the surface of the cathode as hydrogen and hydroxide ions are generated, and a corresponding oxidation reaction occurs at the surface of the anode as oxygen and protons are produced. In the present configuration of the BPED stack, there were many BPED membrane units for each pair of electrodes in the BPED stack. This configuration reduced the hydrogen and oxygen generation by the BPED stack, thereby reducing the quantity of produced hydrogen and oxygen by-products to negligible amounts.

In a laboratory scale set-up, an electrochemical charging system (Germany Digatron power electronics Co., Ltd) was connected to the two electrodes of the BPED stack to supply certain current and voltage. A pH and conductivity meter (Metier Toledo) was used to identify the pH level of generated alkali and acid. It was also used to identify the conductivity level of synthetic seawater during the experiment. Fresh synthetic seawater was added into the system when the conductivity dropped during the experiment. A pump was used to pump synthetic seawater into the BPED stack and acid/base out of the BPED stack to form a recirculating system. A thermostatic water bath (Fisher Scientific) was used to keep synthetic seawater at a constant temperature. A stirrer (Heidolph instruments) was used to keep the concentration of synthetic seawater uniform.

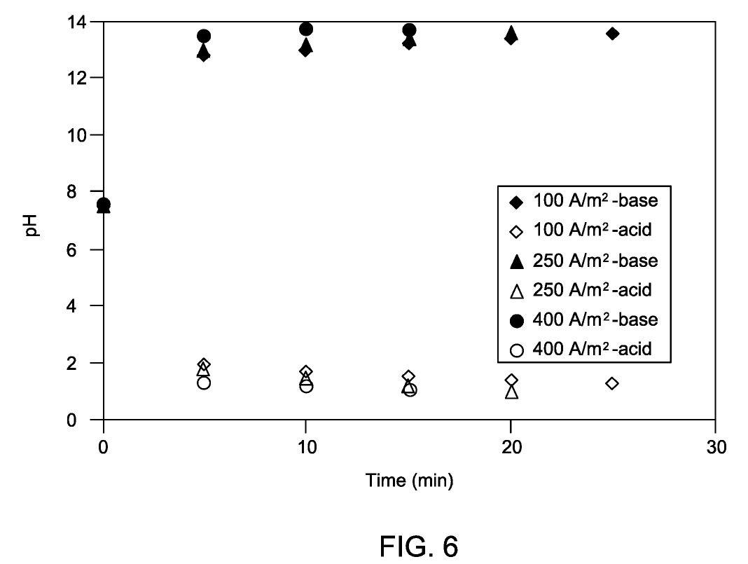

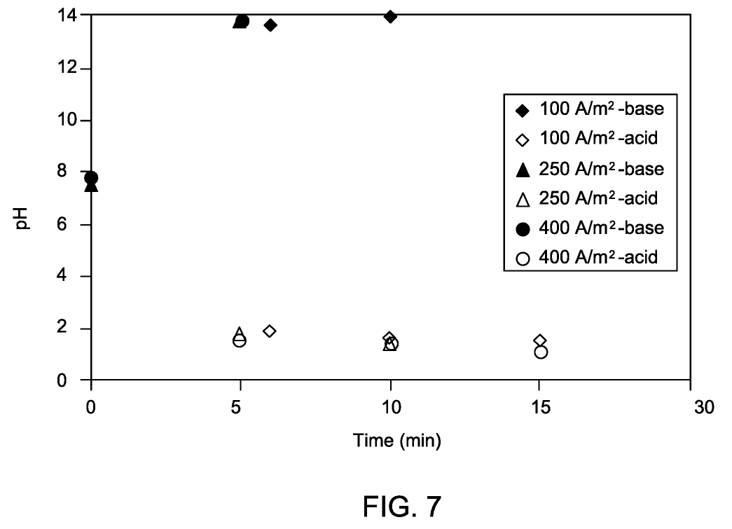

The capability of BPED to produce acid and base from seawater on-site and on-demand are demonstrated in the graphs of FIG. 6 and FIG. 7. FIG. 6 illustrates the laboratory scale experimental results obtained using a BPED unit and synthetic seawater as feed at room temperature and FIG. 7 illustrates the laboratory scale experimental results at room subsea temperature of about 4° C. The results shown in FIG. 6 and FIG. 7 indicate that the pH of the base stream quickly reached 12 and higher, and the pH of the acid stream reached 2-3.5 or lower within minutes, which is adequate for the purpose of membrane cleaning. Further, it was observed that the concentration of the base can reach 2 g/L to 18 g/L, or 0.2% to 1.8% (wt), depending on the reaction time, power density, and temperature. Increasing the charging current and the temperature accelerates acid/base generation rates due to a stronger electrical field and faster ion mobility, respectively. However, higher current density also increased the energy consumption. Experiments were carried out with current densities of 100, 250, and 400 A/m². The current efficiency was found to be in the range of 60% to 85% range for all experiments. At 4° C., which is typical of subsea temperature, and at higher current density, the current efficiency decreased slightly as compared with room temperature current efficiency due to the slower ion mobility.

The laboratory experiments demonstrated the feasibility of using an electro-dialysis unit to generate base and acid on-demand, on-site, for CIP of membranes and other subsea process apparatus. The disclosed lab experiment was conducted on a BPED unit with relatively small membrane area, and the system was in recirculation mode. Commercial BPED units provide considerably larger membrane areas such that the feed water usually is in once-through mode (in contrast to recirculation mode), to produce acid and base directly, without the need for any recirculation.

The demonstrated on-site generation of acid and base from seawater offers great advantages when compared to marinization of conventional onshore CIP systems. These advantages include eco-friendliness, much lower weight and footprint, greatly reduced capital expenditures and operation expenditures and excellent robustness. In addition, the acid/base generation unit's modular design facilitates scale up to larger designs.

The foregoing examples are merely illustrative, serving to illustrate only some of the features of the disclosure. The appended claims are intended to claim the disclosure as broadly as it has been conceived and the examples herein presented are illustrative of selected embodiments from a manifold of all possible embodiments. Accordingly, the appended claims are not to be limited by the choice of examples utilized to illustrate features of the present disclosure. Where necessary, ranges have been supplied, those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

1. A subsea water processing system, comprising:
a microfiltration unit comprising an oil-tolerant microfiltration membrane, wherein the microfiltration unit is configured to receive a stream of produced water that contains oil constituents and suspended solids, and to produce a first treated stream of water;
an ultrafiltration unit comprising an oil-rejecting ultrafiltration membrane, fluidly connected downstream of the microfiltration unit, wherein the ultrafiltration unit is configured to receive the first treated stream of water and to produce a second treated stream of water; and
an electrochemical unit, fluidly connected to at least one of the microfiltration unit or the ultrafiltration unit, wherein the electrochemical unit is configured to produce an acid and a base, and deliver the same to the at least one of the microfiltration unit or the ultrafiltration unit during a cleaning cycle.

2. The subsea water processing system of claim 1, wherein the at least one of the microfiltration unit or the ultrafiltration unit is further configured to receive the acid or the base during the cleaning cycle.

3. The subsea water processing system of claim 2, configured to receive the acid or the base from the electrochemical unit upstream of the at least one of the microfiltration unit or the ultrafiltration unit during a washing step of the cleaning cycle.

4. The subsea water processing system of claim 3, wherein an outlet of the electrochemical unit is fluidly connected to an inlet of the at least one of the microfiltration unit or the ultrafiltration unit.

5. The subsea water processing system of claim 2, configured to receive the acid or the base from the electrochemical unit downstream of the at least one of the microfiltration unit or the ultrafiltration unit during a back washing step of the cleaning cycle.

6. The subsea water processing system of claim 5, wherein an outlet of the electrochemical unit is fluidly connected to an outlet of the at least one of the microfiltration unit or the ultrafiltration unit.

7. The subsea water processing system of claim 1, wherein the electrochemical unit is a bipolar electrodialysis unit configured to produce hydrochloric acid and sodium hydroxide.

8. The subsea water processing system of claim 1, wherein the ultrafiltration unit is further configured to deliver at least a portion of the second treated stream of water to the electrochemical unit.

9. The subsea water processing system of claim 1, further comprising a nanofiltration unit comprising a nanofiltration membrane, fluidly connected upstream of the electrochemical unit, wherein the nanofiltration unit is configured to receive sea water and produce a third treated stream of water and deliver the same to the electrochemical unit.

10. The subsea water processing system of claim 1, wherein the oil-tolerant microfiltration membrane is hydrophilic and oleophobic.

11. The subsea water processing system of claim 1, wherein the oil-rejecting ultrafiltration membrane is in a spiral wound form and comprises a polyacrylonitrile.

12. A subsea water processing system comprising:
(a) a microfiltration unit comprising an oil-tolerant microfiltration membrane, the microfiltration unit configured to receive a stream of produced water comprising solid particulates having a mean particle size under 5 microns and oil constituents in a concentration ranging from about 25 to about 1000 parts per million, and to produce therefrom, during a filtration cycle, a first treated stream of water comprising solid particulates having a mean particle size under 2 microns and at least a 50% reduction in concentration of oil constituents;
(b) an ultrafiltration unit comprising an oil-rejecting, ultrafiltration membrane, the ultrafiltration unit configured to receive the first treated stream of water from the microfiltration unit, and to produce therefrom, during the filtration cycle, a second treated stream of water comprising solid particulates having a mean particle size under 0.01 micron and oil constituents in a concentration of less than 20 parts per million; and
(c) an electrochemical unit configured to produce an acid and a base, and deliver the same to at least one of the microfiltration unit or the ultrafiltration unit during an in situ cleaning cycle.

13. The subsea water processing system of claim 12, wherein the electrochemical unit is a bipolar electrodialysis unit configured to produce hydrochloric acid and sodium hydroxide.

14. The subsea water processing system of claim 13, wherein the at least one of the microfiltration unit or the ultrafiltration unit is configured to receive at least one of the hydrochloric acid or the sodium hydroxide, produced by the bipolar electrodialysis unit.

15. A method of processing produced water under subsea conditions using a subsea water processing system comprising a microfiltration unit comprising an oil-tolerant microfiltration membrane, an ultrafiltration unit comprising an oil-rejecting ultrafiltration membrane and an electrochemical unit, the method comprising:
filtering a stream of produced water using the microfiltration unit and the ultrafiltration unit to produce a stream of treated water during a filtration cycle;
producing in situ an acid and a base in the electrochemical unit; and
periodically washing at least one of the microfiltration unit or the ultrafiltration unit during an in situ cleaning cycle using at least one of the acid or the base produced by the electrochemical unit to clean at least one of the microfiltration unit or the ultrafiltration unit.

16. The method of claim 15, further comprising neutralizing the at least one of the acid or the base after washing, in the in situ cleaning cycle.

17. (canceled)

18. (canceled)

19. The method of claim 15, wherein the in situ cleaning cycle is performed in a flow direction opposite to the filtration cycle.

20. The method of claim 19, wherein the filtration cycle and the in situ cleaning cycle are performed alternately.
